(19) United States
(12) Patent Application Publication
(10) Pub. No.: US 2012/0028104 A1
(43) Pub. Date: Feb. 2, 2012

(54) THERMOPLASTIC FILM, METHODS FOR MAKING SUCH FILM, AND THE USE OF SUCH FILM AS BATTERY SEPARATOR FILM

(75) Inventors: Patrick Brant, Seabrook, TX (US); Derek Thurman, Houston, TX (US); Koichi Kono, Nasushiobara (JP); Kotaro Takita, Nasushiobara (JP)

(73) Assignee: TORAY TONEN SPECIALTY SEPARATOR GODO KAISHA, Nasushiobara, Tochigi (JP)

(21) Appl. No.: 13/264,040

(22) PCT Filed: Apr. 7, 2010
(86) PCT No.: PCT/US2010/030238

§ 371 Date: Oct. 12, 2011

Related U.S. Application Data
(60) Provisional application No. 61/172,075, filed on Apr. 23, 2009.
(60) Provisional application No. 61/172,071, filed on Apr. 23, 2009.
(60) Provisional application No. 61/218,728, filed on Jun. 19, 2009.

(30) Foreign Application Priority Data
Jun. 12, 2009 (EP) 09162565.7

(51) Int. Cl. H01M 2/16; H01M 10/00; B29C 49/00

(52) U.S. Cl. 429/145; 264/510

(57) ABSTRACT

A thermoplastic film including a microporous polymeric membrane; and a non-woven web bonded to the polymeric microporous membrane, wherein the web comprises a plurality of fibers comprising polyolefin having a Tm≧85.0° C. and a Te-Tm≦10.0° C.

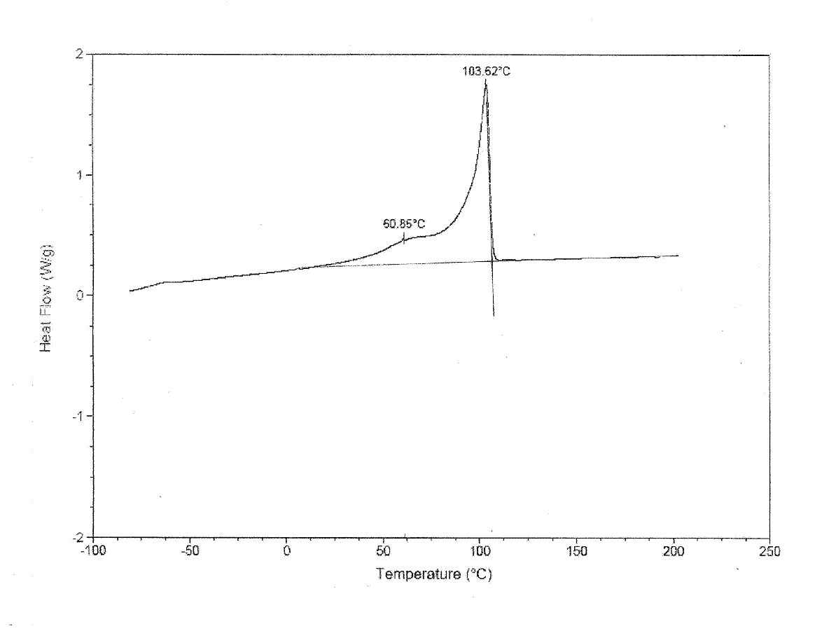

### PRIORITY CLAIM

This application claims priority to and the benefit of U.S. Ser. No. 61/172,071, filed Apr. 23, 2009, U.S. Ser. No. 61/218,728, filed Jun. 19, 2009, U.S. Ser. No. 61/172,075, filed Apr. 23, 2009 and European Application No. EP 09162565.7, filed Jun. 12, 2009, the contents of each of which are incorporated by reference in their entirety.

### FIELD OF INVENTION

Embodiments of the present invention generally relate to thermoplastic film, methods for making thermoplastic film, and the use of thermoplastic film as battery separator film. More particularly, the invention relates to a thermoplastic film comprising a microporous polymeric membrane and a non-woven polymeric web. The non-woven polymeric web can be a meltblown polymeric layer on the microporous polymeric membrane.

### BACKGROUND

Microporous membranes have been used as battery separators in primary and secondary lithium batteries, lithium polymer batteries, nickel-hydrogen batteries, nickel-cadmium batteries, nickel-zinc batteries, and silver-zinc secondary batteries. The performance of such microporous membranes significantly affects the properties, productivity, and safety of the battery.

In most cases, it is desirable for the battery separator film to have a relatively low shutdown temperature (“SDT”) and relatively high meltdown temperature (“MDT”) for improved battery-safety properties, particularly at relatively high battery temperature as might occur as a result of overcharging or rapid discharging. Battery separator film is generally produced with a relatively high permeability for the battery's electrolyte. It is desirable for the battery separator film to retain its electrolyte permeability while the battery is exposed to relatively high temperatures (but below SDT), as might be encountered during battery manufacturing, testing, and use, so that the battery does not experience an undue loss of power or capacity.

U.S. Pat. No. 6,692,868 B2 discloses a meltblown layer laminated on microporous film to lower the film's SDT. The reference discloses a meltblown polyolefin layer having a basis weight of from 6 to 160 grams per square meter. The production of meltblown fibers is generally described in U.S. Pat. No. 3,849,241, U.S. Pat. No. 4,526,733, and U.S. Pat. No. 5,160,746. A web of meltblown polyethylene fibers has been used for separators in NiMH batteries as disclosed in U.S. Pat. No. 6,537,696 and U.S. Pat. No. 6,730,439. These separators, however, are not useful for Li ion batteries because the disclosed monolithic meltblown fabrics have low tensile and puncture strength, and large pore size.

To compensate for low strength, laminates of meltblown and spunbond nonwovens have been made to increase the mechanical properties, but this can be undesirable because separator thickness is increased.

While improvements have been made, there is still a need for relatively thin thermoplastic film useful as battery separator film, the thermoplastic film having a low SDT and capable of retaining high permeability during battery manufacturing and use.

### SUMMARY

In an embodiment, the invention relates to a thermoplastic film comprising:

a microporous polymeric membrane; and

a non-woven web bonded to the polymeric microporous membrane, wherein the web comprises plurality of fibers comprising polyolefin having a Tm≧85.0° C. and a Te-Tm≦10.0° C.

In another embodiment, the invention relates to a method for producing a thermoplastic film comprising combining a non-woven web and a microporous polymeric membrane, the web comprising a plurality of fibers comprising polyolefin having a Tm≧85.0° C. and a Te-Tm≦10.0° C.

In yet another embodiment, the invention relates to a battery comprising an anode, a cathode, an electrolyte, and a separator situated between the anode and the cathode, the separator comprising:

a microporous polymeric membrane; and

a non-woven web bonded to the polymeric microporous membrane, wherein the web comprises plurality of fibers comprising polyolefin having a Tm≧85.0° C. and a Te-Tm≦10° C.

### BRIEF DESCRIPTION OF THE FIGURE

The FIGURE is a plot of DSC data (second melt) from a representative polyethylene sample. The heat supplied to the sample (“heat flow”; Y axis in Watts/gram) is plotted against sample temperature (“Temperature”; X axis in ° C.).

### DETAILED DESCRIPTION

It has been surprisingly found that the SDT of a battery separator film (“BSF”) can be improved without significantly affecting the BSF's permeability by a non-woven, polymeric web (e.g., a layer or coating) disposed on at least one surface thereof, the non-woven web comprising polymer having a melting peak (“Tm”)≦130.0° C. and a melting distribution (“Te-Tm”)≦10.0° C. The web decreases the BSF's SDT (very desirable) without significantly affecting other film properties such as permeability and meltdown temperature.

It is believed that combining a microporous polymeric membrane with a non-woven web from a polymer having a relatively low Tm, a relatively low Mw, and a narrow MWD results in a BSF having a lower SDT without degrading battery performance. Optionally, the web can be laminated to one or more different type(s) of nonwoven web(s) (e.g., a spunbond web) to, for example, increase the strength of the separator or alter the compressibility of the separator.

When the BSF comprises the web and the microporous membrane, the polymer in the web can alter the BSF's permeability by at least partially blocking all or a portion of the membrane's pores at elevated temperature so as to prevent ion flow between the electrodes.

In one or more embodiments, the nonwoven polymeric web can be applied directly to a finished microporous membrane using a meltblown process. The membrane can be fed continuously upon the forming belt in front of a meltblown polymer stream forming a BSF having a composite structure comprising the membrane and the meltblown layer. Meltblown polymer can be applied to one or both sides of the membrane. The meltblown process allows facile adjustment of the fiber diameter and the web basis weight (grams per square meter “g/m²”).

In an embodiment, the non-woven web comprises a mat of meltblown fibers having a basis weight≧1.0 g/m², e.g., in the range of 1.0 g/m² to 50.0 g/m², a thickness of ≦75.0 μm, e.g., in the range of 0.10 μm to 20.0 μm, and an average pore size (i.e., equivalent diameter) of 0.30 μm to 50.0 μm. In an embodiment, the fibers have diameters, e.g., in the range of 0.10 μm to 13.0 μm with a majority (>50.0% by number) of the fibers having diameters less than 0.5 μm, and having lengths that are substantially continuous, e.g., ≧12.0 mm. In another embodiment, a majority of the fibers (e.g. ≧85% of the fibers, by number) have diameters≧0.5 μm and have substantially continuous length, e.g., ≧12.0 mm. Optionally, the web's basis weight is in the range of from 2.0 g/m² to 50.0 g/m² and web thickness is in the range of from 1.0 μm to 10.0 μm. Optionally, the web's average pore size is in the range of from 1.0 μm to 25.0 μm and the web's fibers have diameters in the range of 0.10 μm to 5.0 μm, with ≧85% of the fibers (by number) having diameters≦0.5 μm. Fiber diameter is measured using Scanning Electron Microscope (SEM) image analysis as follows.

A sample comprising the non-woven web (e.g., the web alone or combined with the thermoplastic film) is cut to a size of about 3 mm×3 mm and mounted on the SEM observation stage using adhesive tape. Platinum is deposited on the sample (current of 20 mA for 40 sec) in a vacuum chamber at a pressure≦10 Pa.

Following platinum deposition, the SEM stage is mounted on a field emission scanning electron microscope (e.g., SEM JSM-6701F available from JEOL co. Ltd.). Images are obtained at magnification factors in the range of 0.25K to 30K, using an acceleration voltage of 2 KV and exposure current of 7 MA. Fiber and web characteristics are measured directly from the images using the methods described in C. J. Ellison, et al., Polymer 48 (2007) 3306-3316.

In an embodiment the non-woven polymeric web is made by meltblowing polymer having a Tm≦130.0° C. and Te-Tm≦10.0° C. Optionally, the polymer has a weight average molecular weight (“Mw”)≦100,000 and a molecular weight distribution (“MWD”, defined as weight average molecular weight divided by number average molecular weight)≦6.0. Optionally, the polymer has a Tm in the range of 85.0° C. to 130.0° C. and has a Te-Tm is in the range of 1.0° C. to 5.0° C. The web is bonded to the microporous membrane to produce the thermoplastic film. For example, the web can be meltblown on a microporous membrane (e.g., as a layer or coating). Alternatively, the web can be first meltblown away from the microporous membrane and then joined to the microporous membrane, e.g., by lamination (such as thermal or sonic bonding) or with an adhesive.

Polymer used to Produce the Non-Woven Web

In an embodiment, the non-woven web is produced from polyolefin, including, e.g., mixtures (such as physical blends) or reactor blends of polyolefins. Optionally, the non-woven web is produced from polyethylene, where the polyethylene comprises polyolefin (homopolymer or copolymer) containing recurring ethylene units. Optionally, the polyethylene comprises polyethylene homopolymer and/or polyethylene copolymer wherein at least 85% (by number) of the recurring units are ethylene units. In an embodiment, the polyolefin used to produce the non-woven web is substantially free of post-polymerization Mw-reducing species (e.g., peroxides) as are typically present in commercially-available polyolefin produced for melt-blowing applications. Substantially-free in this context means ≦100.0 ppm, e.g., ≦50.0 ppm, such as ≦10.0 ppm based on the weight of the polyolefin used to produce the non-woven web. It has been discovered that the presence of such post-polymerization Mw-reducing species undesirably affects electrochemical activity when the non-woven web is present in a battery.

In an embodiment, the non-woven web is produced from polyethylene having a Tm≦130.0° C. and a Te-Tm≦10° C. When the Tm is significantly >130.0° C., it is more difficult to produce a non-woven web that when combined with the microporous membrane produces a thermoplastic film having a shutdown temperature≦130.5° C.

Optionally, the polyethylene has a Tm≧85.0° C., e.g., in the range of from 95.0° C. to 130.0° C., such as 100.0° C. to 126.0° C., or 115.0° C. to 125.0° C., or 121.0° C. to 124.0° C. Optionally, the polyethylene has an Mw in the range of from 5.0×10³ to 1.0×10⁵, e.g., in the range of from 1.5×10⁴ to 5.0×10⁴; and an MWD in the range of from 1.5 to 5.0, e.g., 1.8 to 3.5. Optionally, the polyethylene has a density in the range of 0.905g/cm³ to 0.935 g/cm³. Polyethylene mass density is determined in accordance with A.S.T.M. D1505.

Optionally, the polyethylene is a copolymer of ethylene and ≦10.0 mol. % of a comonomer such as α-olefin. The comonomer can be, e.g., one or more of propylene, butene-1, pentene-1, hexene-1,4-methylpentene-1, octene-1, vinyl acetate, methyl methacrylate, styrene, or other monomer. In an embodiment, the comonomer is hexene-1 and/or or octene-1.

When the polyethylene is a copolymer, the polyethylene copolymer optionally has a Composition Distribution Breadth Index (“CDBI” as hereinafter defined)≧50.0%, e.g., ≧75.0%, such as ≧90.0%. Optionally, the polyethylene copolymer has a relatively narrow compositional distribution, as hereinafter defined.

Optionally, the polyethylene has a Te-Tm in the range of 1.0° C. to 5.0° C., e.g., in the range of 2.0° C. to 4.0° C. The melting distribution (Te-Tm) is a characteristic of the polyethylene resulting from the polymer's structure and composition. For example, some of the factors influencing melting distribution include the Mw, MWD, branching ratio, the molecular weight of branched chains, the amount of comonomer (if any), comonomer distribution along the polymer chains, the size and distribution of polyethylene crystals in the polyethylene and crystal lattice regularity.

Optionally, the polyethylene has a melt index≧1.0×10², e.g., in the range of from 125 to 1500, such as from 150 to 1000. It is believed that when polyethylene melt index is ≧100, it is easier to produce the non-woven web, particularly when the non-woven web is produced directly on the microporous membrane. Polyethylene melt index is determined in accordance with A.S.T.M. D1238.

The polymer used to produce the non-woven web can be made in any convenient process, such as those using a Ziegler-Natta or single-site polymerization catalyst. Optionally, the first polyethylene is one or more of a low density polyethylene (“LDPE”), a medium density polyethylene, a branched low density polyethylene, or a linear low density polyethylene, such as a polyethylene produced by metallocene catalyst. The polymer can be produced according to the methods disclosed in U.S. Pat. No. 5,084,534 (such as the methods disclosed therein in examples 27 and 41), which is incorporated by reference herein in its entirety.

### Determining Tm, Te-Tm, Mw, MWD, and CDBI

Peak melting point (“Tm”) in ° C. and melting peak endpoint (“Te”) in ° C. are determined using differential scanning calorimetry (“DSC”), e.g., using a TA Instruments model 2920 calorimeter as follows. Samples weighing approximately 7-10 mg are molded and sealed in aluminum sample pans for 48 hours at room temperature (21° C. to 25° C.) before the DSC measurement. DSC data is then recorded by exposing the sample to a first temperature of −50° C. (the “first cooling cycle”) and then exposing the sample to an increasing temperature at a rate of 10° C./minute to a second temperature of 200° C. (the “first heating cycle”). The sample is maintained at 200° C. for 5 minutes and then exposed to a decreasing temperature at a rate of 10° C./minute to a third temperature of −50° C. (the “second cooling cycle”). The sample temperature is again increased at 10° C./minute to 200° C. (the “second heating cycle”). Tm and Te are obtained from the data of the second heating cycle. Tm is the temperature of the maximum heat flow to the sample in the temperature range of −50° C. to 200° C. Polyethylene may show secondary melting peaks adjacent to the principal peak, and/or the end-of-melt transition, but for purposes herein, such secondary melting peaks are considered together as a single melting point, with the highest of these peaks being considered the Tm. Te is the temperature at which the melting is effectively complete, as determined from the DSC data by the intersection of an initial tangent line and a final tangent line. The initial tangent line is a line drawn tangent to DSC data on the high temperature side of the Tm peak at a temperature corresponding to a heat flow of 0.5 times the maximum heat flow to the sample. The initial tangent line has a negative slope as the heat flow diminishes toward the baseline. The final tangent line is a line drawn tangent to the DSC data along the measured baseline between Tm and 200° C. A plot of DSC data for a representative polyethylene sample during the second heating cycle is shown in the FIGURE. The polyethylene Tm is 103.62° C., and a secondary melting peak at 60.85° C. The intersection of the initial and final tangent lines as shown in the FIGURE yields a Te of approximately 106.1° C.

Polyethylene Mw and MWD are determined using a High Temperature Size Exclusion Chromatograph, or “SEC”, (GPC PL 220, Polymer Laboratories), equipped with a differential refractive index detector (DRI). Three PLgel Mixed-B columns available from (available from Polymer Laboratories) are used. The nominal flow rate is 0.5 cm³/min, and the nominal injection volume is 300 μL. Transfer lines, columns, and the DRI detector are contained in an oven maintained at 145° C. The measurement is made in accordance with the procedure disclosed in “Macromolecules, Vol. 34, No. 19, pp. 6812-6820 (2001)”.

The GPC solvent used is filtered Aldrich reagent grade 1,2,4-Trichlorobenzene (TCB) containing approximately 1000 ppm of butylated hydroxy toluene (BHT). The TCB is degassed with an online degasser prior to introduction into the SEC. Polymer solutions are prepared by placing dry polymer in a glass container, adding the desired amount of the above TCB solvent, then heating the mixture at 160° C. with continuous agitation for about 2 hours. The concentration of polymer in the solution is 0.25 to 0.75 mg/ml. Sample solution is filtered off-line before injecting to GPC with 2 μm filter using a model SP260 Sample Prep Station (available from Polymer Laboratories).

The separation efficiency of the column set is calibrated with a calibration curve generated using a seventeen individual polystyrene standards ranging in Mp (“Mp” being defined as the peak in Mw) from about 580 to about 10,000,000. The polystyrene standards are obtained from Polymer Laboratories (Amherst, Mass.). A calibration curve (log Mp vs. retention volume) is generated by recording the retention volume at the peak in the DRI signal for each PS standard and fitting this data set to a 2nd-order polynomial. Samples are analyzed using IGOR Pro, available from Wave Metrics, Inc.

CDBI is defined as the percent by weight of polyethylene copolymer whose composition is within 50% by weight of the median comonomer composition in the polyethylene's composition distribution. The “composition distribution” can be measured according to the following procedure. About 30 g of the copolymer is cut into small cubes about 3 mm per side. These cubes are introduced into a thick walled glass bottle closed with screw cap along with 50 mg of Irganox 1076, an antioxidant commercially available from Ciba-Geigy Corporation. Then, 425 ml of hexane (a mixture of normal and iso isomers) is added to the contents of the bottle and the sealed bottle is maintained at about 23° C. for about 24 hours. At the end of this period, the solution is decanted and the residue is treated with additional hexane for an additional 24 hours. At the end of this period, the two hexane solutions are combined and evaporated to yield a residue of the copolymer soluble at 23° C. To the residue is added sufficient hexane to bring the volume to 425 mL and the bottle is maintained at about 31° C. for 24 hours in a covered circulating water bath. The soluble copolymer is decanted and the additional amount of hexane is added for another 24 hours at about 31° C. prior to decanting. In this manner, fractions of the copolymer component soluble at 40° C., 48° C., 55° C., and 62° C. are obtained at temperature increases of approximately 8° C. between stages. Increases in temperature to 95° C. can be accommodated if heptane instead of hexane is used as the solvent for all temperatures about 60° C. The soluble copolymer fractions are dried, weighed and analyzed for composition, as for example by weight percent ethylene content. Soluble fractions obtained from samples in the adjacent temperature ranges are the “adjacent fractions”. A copolymer is said to have a “narrow compositional distribution” when at least 75 wt. % of the copolymer is isolated in two adjacent fractions, each fraction having a composition difference of no greater than 20% of the copolymer's average wt. % monomer content.

### Method for Producing the Non-Woven Web

The non-woven web can be produced by any convenient method, including conventional web-forming methods such as meltblowing, spun bonding, electrospinning, etc. In an embodiment, the non-woven web is produced by meltblowing. While the production of the web will be described in terms of meltblowing, the invention is not limited thereto, and the description of the meltblowing embodiments is not meant to foreclose other embodiments within the broader scope of the invention.

Meltblowing produces a web of fibers formed by extruding a molten polymer through a plurality of fine, usually circular, die capillaries as molten threads or filaments into converging, usually hot and high velocity, gas streams (e.g., air or nitrogen) to attenuate the filaments of molten polymer and form fibers. The diameter of the molten filaments is reduced by the drawing air to achieve a desired size. Thereafter, the meltblown fibers are carried by the high velocity gas stream and are deposited on a collecting surface to form at least one web of randomly-disbursed meltblown fibers.

The meltblown fibers can be continuous or discontinuous and are generally smaller than 10.0 μm in average diameter. For example, the fibers can have an average diameter in the range of 0.1 μm to 10.0 μm, such as 0.5 μm to 8.0 μm, or 1.0 μm to 5.0 μm. Average fiber length is generally ≧12.0 mm. The web can have a basis weight in the range of from 1.0 to 50.0 g/m², such as in the range of 4.0 g/m² to 35.0 g/m², a thickness of ≦75.0 μm, and an average pore size of 0.30 to 50.0 μm. Optionally, the fibers have an aspect ratio (average length divided by average diameter)≧1.0×10³; e.g., in the range of 1.0×10⁴ to 1.0×10⁷.

During meltblowing, molten polymer is provided to a die that is disposed between a pair of air plates that together form a primary air nozzle. Standard meltblown equipment includes a die tip with a single row of capillaries along a knife edge. The die tips can have, e.g., approximately 30 capillary exit holes per linear inch (25.4 mm) of die width. The number of capillary exit holes per linear measure of die width is not critical, and can be, e.g., ≦1 capillary exit hole per linear cm, e.g., in the range of 1 to 100, such as in the range of 5 to 50 capillary exit holes per linear cm of die width. The die tip is typically a 60° wedge-shaped block converging at the knife edge at the point where the capillaries are located. Optionally, the air plates are mounted in a recessed configuration such that the tip of the die is set back from the primary air nozzle. Alternatively, the air plates can be mounted in a flush configuration where the air plate ends are in the same horizontal plane as the die tip; or in a protruding or “stick-out” configuration where the tip of the die extends past the ends of the air plates. Optionally, more than one air flow stream can be used.

Optionally, hot air is provided through the primary air nozzle formed on each side of the die tip. The hot air heats the die and thus prevents the die from clogging with solidified polymer as the molten polymer exits and conducts heat away from the die. The hot air also draws, or attenuates, the melt into fibers. Alternatively, heated gas can be used to maintain polymer temperature in the polymer reservoir, as is disclosed in U.S. Pat. No. 5,196,207. Secondary, or quenching, air at a temperature above ambient can be provided through the die head if desired. Optionally, the primary hot air flow rate is in the range of from about 9.5 liters/sec. to 11.3 liters/sec. per 2.54 cm of die width (approximately 20 to 24 standard cubic feet per minute, “SCFM”, per inch of die width). When the melt-blown web is produced on a microporous membrane (used, e.g., as a substrate), the primary hot air flow rate should be in the range of 3.75 liters/sec to 8.0 liters/sec. per 2.5 cm of die width (approximately 8 to 17 SCFM per inch of die width).

Optionally, the air pressure of the primary hot air is in the range of from 115 kPa or 140 kPa to 160 kPa or 175 kPa or 205 kPa at a point in the die head just prior to exit. Optionally, the primary hot air temperature is ≦450° C. or 400° C., e.g., in the range of 200° C. or 230° C. to 300° C. or 320° C. or 350° C. The particular temperature selected for the primary hot air flow will depend on the particular polymer being drawn. The primary hot air temperature and the polymer's melt temperature are selected to be sufficient to form a melt of the polymer but below the polymer's decomposition temperature. Optionally, the melt temperature is in the range of from 200° C. or 220° C. to 280° C. or 300° C. Optionally, polymer throughput is in the range of from 0.10 grams per hole per minute (ghm) or 0.2 ghm or 0.3 ghm to 1.0 ghm or 1.25 ghm, expressed in terms of the amount of composition flowing per inch (25.4 mm) of the die per unit of time. In an embodiment where the die has 12 holes/cm, polymer throughput is optionally about 2.3 kg/cm/hour to 6.0 kg/cm/hour or 8.0 kg/cm/hour or 9.5 kg/cm/hour. Optionally, the polymer is meltblown at a melt temperature in the range of from 220° C. or 240° C. to 280° C. or 300° C.; and a throughput within the range of from 0.1 or 0.2 ghm to 1.25 ghm or 2.0 ghm.

Since the die operates at high temperature, it can be advantageous to use a cooling medium such as cooled gases (e.g., air) to accelerate cooling and solidification of the meltblown fibers. In particular, secondary air flowing in a cross-flow (e.g., substantially perpendicular, or 90°) direction relative to the direction of fiber elongation (“attenuating air flow”), can be used to quench meltblown fibers. Using such secondary air can make it easier to produce relatively small diameter fibers, e.g., in the range of 2.0 μm to 5.0 μm. In addition, a cooler pressurized quench air may be used and can result in faster cooling and solidification of the fibers. Through the control of air and die tip temperatures, air pressure, and polymer feed rate, the diameter of the fiber formed during the meltblown process may be regulated. In one or more embodiments, meltblown fibers produced herein have a diameter within the range of 0.5 μm or 1.0 μm or 2.0 μm to 3.0 μm or 4.0 μm or 5.0 μm.

The meltblown fibers are collected to form a nonwoven web. In an embodiment, the fibers are collected on a forming web that includes a moving mesh screen or belt located below the die tip. In order to provide enough space beneath the die tip for fiber forming, attenuation and cooling, a web-forming distance of about 200.0 mm to 300.0 mm is provided between the die tip and the top of the substrate (e.g., a mesh screen). Web-forming distances as low as 100.0 mm can be used. When the web is formed on a microporous membrane (e.g., when the membrane is a substrate), the web-forming distance is 150.00 mm, e.g., in the range of 50.0 to 150.0 mm, such as 75.0 mm to 125.0 mm. The shorter web-forming distances may be achieved using an attenuating air flow that is at least 30.0° C. cooler than the temperature of the molten polymer in the die. Optionally, the web is formed directly upon another fabric and then laminated with the membrane. Additional details can be found in U.S. Pat. Nos. 6,692,868, 6,114,017, 5,679,379, and 3,978,185 which are incorporated by reference herein in their entirety.

### Composite Structure

In an embodiment, the non-woven web is combined with a microporous membrane by, e.g., lamination or by producing the web on the membrane, where the phrase “producing the web on the membrane” means that the non-woven polymeric web is meltblown onto the microporous membrane. In other words, in an embodiment where the web is produced on the membrane, the non-woven polymeric web is formed at the time it is applied to the microporous membrane. The combined web and microporous membrane, e.g., in the form of a layered thermoplastic film, is useful as battery separator film. A second non-woven web can be combined with the microporous membrane, if desired. The second web, which can be produced by the same methods and from the same materials as the first web, can be combined with the microporous membrane by, e.g., lamination or producing the second web on the first web or on a second surface of the microporous membrane. The thermoplastic film comprising microporous membrane and non-woven web can have, e.g., an A/B/A structure, an A/B/C structure, an A/B1/A/B2/(A, B1, C, or D) structure, an A/B1/C/B2/(A, B1, C, or D), or combinations and continuations (repeating or otherwise) thereof. In these exemplary structures, A represents a non-woven web, B1, B2, etc. represent microporous membrane(s), C represents a second non-woven web, and D represents either a non-woven web or a microporous membrane.

### Microporous Membrane

In an embodiment, the microporous membrane is an extrudate produced from at least one diluent and at least one polyolefin. The polyolefin can be any polyolefin, including polyethylene, polypropylene, homopolymers thereof and copolymers thereof. Optionally, inorganic species (such as species containing silicon and/or aluminum atoms), and/or heat-resistant polymers such as those described in PCT Publications WO 2007/132942 and WO 2008/016174 (both of which are incorporated by reference herein in their entirety) can be used to produce the extrudate. In an embodiment, these optional species are not used. In at least one specific embodiment, the extrudate includes a first polyethylene and/or a second polyethylene and/or a polypropylene, each described below. Optionally, the polyolefin used to produce the membrane (the polyethylene and/or polypropylene) further comprises the polymer used to produce the non-woven web.

### The First Polyethylene

The first polyethylene has an Mw−1.0×10⁶, e.g., in the range of from about 1.0×10⁵ to about 9.0×10⁵, for example from about 4.0×10⁵ to about 8.0×10⁵. Optionally, the polyethylene has an MWD≦50.0, e.g., in the range of from about 2.0 to about 30.0, such as from about 3.0 to about 20.0. For example, the first polyethylene can be one or more of a high density polyethylene (“HPDE”), a medium density polyethylene, a branched low density polyethylene, or a linear low density polyethylene.

In an embodiment, the first polyethylene has an amount of terminal unsaturation≧0.20 per 10,000 carbon atoms, e.g., ≧5.0 per 10,000 carbon atoms, such as ≧10.0 per 10,000 carbon atoms. The amount of terminal unsaturation can be measured in accordance with the procedures described in PCT Publication WO97/23554, for example.

In an embodiment, the first polyethylene is at least one of (i) an ethylene homopolymer or (ii) a copolymer of ethylene and ≦10 mol. % of a comonomer such as polyolefin. The comonomer can be, for example, one or more of propylene, butene-1, pentene-1, hexene-1, 4-methylpentene-1, octene-1, vinyl acetate, methyl methacrylate, or styrene.

### The Second Polyethylene

The second polyethylene has an Mw>1.0×10⁶, e.g., in the range of 1.1×10⁶ to about 5.0×10⁶, for example from about 1.2×10⁶ to about 3.0×10⁶, such as about 2.0×10⁶. Optionally, the second polyethylene has an MWD≦50.0, e.g., from about 2.0 to about 30.0, such as from about 4.0 to about 20.0 or about 4.5 to 10.0. For example, the second polyethylene can be an ultra-high molecular weight polyethylene (“UHMWPE”). In an embodiment, the second polyethylene is at least one of (i) an ethylene homopolymer or (ii) a copolymer of ethylene and ≦10.0 mol. % of a comonomer such as polyolefin. The comonomer can be, for example, one or more of propylene, butene-1, pentene-1, hexene-1, 4-methylpentene-1, octene-1, vinyl acetate, methyl methacrylate, or styrene. Such a polymer or copolymer can be produced using a single-site catalyst.

The Mw and MWD of the first and second polyethylenes are determined using the procedure described in the production of the non-woven web.

### The Polypropylene

The polypropylene has an Mw≧1.0×10⁵, for example ≧1.0×10⁶, or in the range of from about 1.05×10⁶ to about 2.0×10⁶, such as from about 1.1×10⁶ to about 1.5×10⁶. Optionally, the polypropylene has an MWD≦50.0, e.g., from about 1.0 to about 30.0, or about 2.0 to about 6.0; and/or a heat of fusion (“ΔHm”)≧80.0 J/g or ≧1.0×10² J/g, e.g., 110.0 J/g to 120.0 J/g, such as from about 113.0 J/g to 119.0 J/g or from 114.0 J/g to about 116.0 J/g. The polypropylene can be, for example, one or more of (i) a propylene homopolymer or (ii) a copolymer of propylene and ≦10.0 mol. % of a comonomer. The copolymer can be a random or block copolymer. The comonomer can be, for example, one or more of α-olefins such as ethylene, butene-1, pentene-1, hexene-1, 4-methylpentene-1, octene-1, vinyl acetate, methyl methacrylate, and styrene, etc.; and diolefins such as butadiene, 1,5-hexadiene, 1,7-octadiene, 1,9-decadiene, etc. Optionally, the polypropylene has one or more of the following properties: (i) the polypropylene is isotactic; (ii) the polypropylene has an elongational viscosity of at least about 50,000 Pa sec at a temperature of 230° C. and a strain rate of 25 sec⁻¹; (iii) the polypropylene has a melting peak (second melt) of at least about 160° C.; and/or (iv) the polypropylene has a Trouton's ratio of at least about 15 when measured at a temperature of about 230° C. and a strain rate of 25 sec⁻¹.

The polypropylene's ΔHm, Mw, and MWD are determined by the methods disclosed in PCT Patent Publication No. WO2007/132942, which is incorporated by reference herein in its entirety. Optionally, the polypropylene is selected from among those disclosed in WO2007/132942.

In an embodiment, the polyolefin used to produce the extrudate comprises polypropylene present in an amount of from 1.0 wt. % to 50.0 wt. %, first polyethylene in an amount in the range of from 25.0 wt. % to 99.0 wt. %, and second polyethylene in the range of from 0 wt. % to 50.0 wt. %. The weight percents of the polypropylene and first and second polyethylenes are based on the weight of the polymer used to produce the extrudate. When the membrane comprises the polypropylene in amount >2.0 wt. %, and particularly >2.5 wt. %, the membrane generally has a meltdown temperature that is higher than that of a membrane which does not contain a significant amount of polypropylene.

In another embodiment, the membrane does not contain a significant amount of polypropylene. In this embodiment, the polyolefin used to produce the extrudate comprises less than 0.10 wt. % polypropylene, such as when the polyolefin consists of or consists essentially of polyethylene. In this embodiment, the amount of second polyethylene used to produce the extrudate can be, e.g., in the range of from 1.0 wt. % to 50.0 wt. %, such as from about 10.0 wt. % to about 40.0 wt. %; and the amount of first polyethylene used to produce the extrudate can be, e.g., in the range of from 60.0 wt. % to 99.0 wt. %, such as from about 70.0 wt. % to about 90.0 wt. %. The weight percents of the first and second polyethylenes are based on the weight of the polymer used to produce the extrudate.

### Extrudate

The extrudate is produced by combining polymer and at least one diluent. The amount of diluent used to produce the extrudate can be in the range, e.g., of from about 25.0 wt. % to about 99.0 wt. % based on the weight of the extrudate, with the balance of the weight of the extrudate being the polymer used to produce the extrudate, e.g., the combined first polyethylene and second polyethylene.

The diluent is generally compatible with the polymers used to produce the extrudate. For example, the diluent can be any species capable of forming a single phase in conjunction with the resin at the extrusion temperature. Examples of the diluent include aliphatic or cyclic hydrocarbon such as nonane, decane, decalin and paraffin oil, and phthalic acid ester such as dibutyl phthalate and dioctyl phthalate. Among them, preferable is paraffin oil, which has a high boiling point, and contains small amount of volatile components. Paraffin oil with kinetic viscosity of 20-200 cSt at 40° C. can be used. The diluent can be the same as those described in U.S. Patent Publication Nos. 2008/0057388 and 2008/0057389, both of which are incorporated by reference in their entirety.

While the extrudate and the microporous membrane can contain copolymers, inorganic species (such as species containing silicon and/or aluminum atoms), and/or heat-resistant polymers such as those described in PCT Publication WO 2008/016174, these are not required. In an embodiment, the extrudate and membrane is substantially free of such materials. Substantially free in this context means the amount of such materials in the microporous membrane is less than 1 wt. %, or less than 0.1 wt. %, or less than 0.01 wt. %, based on the total weight of the polymer used to produce the extrudate.

The microporous membrane generally comprises the polyolefin used to produce the extrudate. A small amount of diluent or other species introduced during processing can also be present, generally in amounts less than 1 wt. % based on the weight of the microporous membrane. A small amount of polymer molecular weight degradation might occur during processing, but this is acceptable. In an embodiment, molecular weight degradation during processing, if any, causes the MWD of the polymers in the membrane to differ from the MWD of the polymers used to produce the membrane by no more than about 50%, or no more than about 1%, or no more than about 0.1%.

In one or more embodiments, the microporous membrane comprises (a) from 1.0 wt. % to 50.0 wt. %, e.g., from about 2.5 wt. % to about 40.0 wt. %, such as from about 5.0 wt. % to about 30.0 wt. %, of polypropylene; (b) from 25.0 wt. % to 99.0 wt. %, e.g., from about 50.0 wt. % to about 90.0 wt. %, such as 60.0 wt. % to about 80.0 wt. % of a first polyethylene; and (c) from 0 wt. % to 50.0 wt. %, e.g., from about 5.0 wt. % to about 30.0 wt. %, such as about 10.0 wt. % to about 20.0 wt. % of a second polyethylene; the first polyethylene having an Mw≦1.0×10⁶, e.g., in the range of from about 1.0×10⁵ toabout 9.0×10⁵, such as from about 4.0×10⁵ to about 8.0×10⁵, and an MWD≦50.0, e.g., in the range of from about 1.0 to about 30.0, such as from about 3.0 to about 20.0; the second polyethylene having an Mw>1.0×10⁶, e.g., in the range of about 1.1×10⁶ to about 5.0×10⁶, such as from about 1.2×10⁶ to about 3.0×10⁶, and an MWD≦50.0, e.g., from about 2.0 to about 30.0, such as from about 4.0 to about 20.0; and the polypropylene having an Mw>1.0×10⁶, e.g., from about 1.05×10⁶ toabout 2.0×10⁶, such as about 1.1×10⁶ to about 1.5×10⁶, an MWD≦50.0, e.g., from about 1.0 to about 30.0, such as about 2.0 to about 6.0, and a ΔHm≧1.0×10² J/g, e.g., about 110.0 J/g to about 120.0 J/g, such as about 114.0 J/g to about 116.0 J/g.

In another embodiment, the microporous membrane contains polypropylene in an amount<0.1 wt. %, based on the weight of the microporous membrane. Such a membrane can comprise, for example, (a) from 1.0 wt. % to 50.0 wt. %, e.g., from about 10.0 wt. % to about 40.0 wt. %, of the second polyethylene; and (b) from 60.0 wt. % to 99.0 wt. %, e.g., from about 70.0 wt. % to about 90.0 wt. % of the first polyethylene; the first polyethylene having an Mw≦1.0×10⁶, e.g., in the range of from about 1.0×10⁵ to about 9.0×10⁵, such as from about 4.0×10⁵ toabout 8.0×10⁵, and an MWD≦50.0, e.g., in the range of from about 1.0 to about 30.0, such as from about 3.0 to about 20.0; and the second polyethylene having an Mw>1.0×10⁶, e.g., in the range of 1.1×10⁶ to about 5.0×10⁶, such as from about 1.2×10⁶ to about 3.0×10⁶, and an MWD≦50.0, e.g., from about 2.0 to about 30.0, such as from about 4.0 to about 20.0.

Optionally, the fraction of polyolefin in the membrane having a molecular weight>1.0×10⁶ is at least 1 wt. %, based on the weight of the polyolefin in the membrane, e.g., at least 2.5 wt. %, such as in the range of about 2.5 wt. % to 50.0 wt. %.

Optionally, the membrane contains ≦20 wt. % of the polymer used to produce the web, based on the weight of the membrane.

### Method of Producing the Microporous Membrane

In one or more embodiments, the microporous membrane is produced by a process comprising: combining polymer and diluent, extruding the combined polymer and diluent through a die to form an extrudate; optionally cooling the extrudate to form a cooled extrudate, e.g., a gel-like sheet; stretching the cooled extrudate in at least one planar direction, or both; removing at least a portion of the diluent from the extrudate or cooled extrudate to form the membrane. Optionally, the process includes removing any remaining volatile species from the membrane; stretching the membrane, and/or heat setting the membrane. Optionally, the extrudate can be heat set before diluent removal, e.g., after extrudate stretching.

An optional hot solvent treatment step, an optional cross-linking step with ionizing radiation, and an optional hydrophilic treatment step, etc., as described in PCT Publication WO2008/016174 can be conducted if desired. Neither the number nor order of the optional steps is critical.

### Combining Polymer and Diluent

The polymers as described above can be combined, e.g., by dry mixing or melt blending, and then the combined polymers can be combined with at least one diluent (e.g., a membrane-forming solvent) to produce a mixture of polymer and diluent, e.g., a polymeric solution. Alternatively, the polymer(s) and diluent can be combined in a single step. The polymer-diluent mixture can contain additives such as one or more antioxidant. In one or more embodiments, the amount of such additives does not exceed 1 wt. % based on the weight of the polymeric solution.

The amount of diluent used to produce the extrudate is not critical, and can be in the range, e.g., of from about 25 wt. % to about 99 wt. % based on the weight of the combined diluent and polymer, with the balance being polymer, e.g., the combined first and second polyethylene.

### Extruding

In one or more embodiments, the combined polymer and diluent are conducted from an extruder to a die, and then extruded through the die to produce the extrudate. The extrudate or cooled extrudate should have an appropriate thickness to produce, after the stretching steps, a final membrane having the desired thickness (generally 3 μm or more). For example, the extrudate can have a thickness in the range of about 0.1 mm to about 10 mm, or about 0.5 mm to 5 mm. Extrusion is generally conducted with the mixture of polymer and diluent in the molten state. When a sheet-forming die is used, the die lip is generally heated to an elevated temperature, e.g., in the range of 140° C. to 250° C. Suitable process conditions for accomplishing the extrusion are disclosed in PCT Publications WO 2007/132942 and WO 2008/016174. The machine direction (“MD”) is defined as the direction in which the extrudate is produced from the die. The transverse direction (“TD”) is defined as the direction perpendicular to both MD and the thickness direction of the extrudate. The extrudate can be produced continuously from a die, or it can be produced from the die in portions (as is the case in batch processing) for example. The definitions of TD and MD are the same in both batch and continuous processing.

### Formation of a Cooled Extrudate

The extrudate can be exposed to a temperature in the range of 15° C. to 25° C. to form a cooled extrudate. Cooling rate is not particularly critical. For example, the extrudate can be cooled at a cooling rate of at least about 30° C./minute until the temperature of the extrudate (the cooled temperature) is approximately equal to the extrudate's gelation temperature (or lower). Process conditions for cooling can be the same as those disclosed in PCT Publications No. WO 2008/016174 and WO 2007/132942, for example.

### Stretching the Extrudate

The extrudate or cooled extrudate is stretched in at least one direction. The extrudate can be stretched by, for example, a tenter method, a roll method, an inflation method or a combination thereof, as described in PCT Publication No. WO 2008/016174, for example. The stretching may be conducted monoaxially or biaxially, though the biaxial stretching is preferable. In the case of biaxial stretching, any of simultaneous biaxial stretching, sequential stretching or multi-stage stretching (for instance, a combination of the simultaneous biaxial stretching and the sequential stretching) can be used, though simultaneous biaxial stretching is preferable. When biaxial stretching is used, the amount of magnification need not be the same in each stretching direction.

The stretching magnification can be, for example, 2 fold or more, preferably 3 to 30 fold in the case of monoaxial stretching. In the case of biaxial stretching, the stretching magnification can be, for example, 3 fold or more in any direction, namely 9 fold or more, such as 16 fold or more, e.g. 25 fold or more, in area magnification. An example for this stretching step would include stretching from about 9 fold to about 49 fold in area magnification. Again, the amount of stretch in either direction need not be the same.

While not required, the stretching can be conducted while exposing the extrudate to a temperature in the range of from about the Tcd temperature Tm.

Tcd and Tm are defined as the crystal dispersion temperature and melting point of the polyethylene having the lowest melting point among the polyethylenes used to produce the extrudate. The crystal dispersion temperature is determined by measuring the temperature characteristics of dynamic viscoelasticity according to ASTM D 4065. In one or more embodiments where Tcd is in the range of about 90° C. to 100° C., the stretching temperature can be from about 90° C. to 125° C.; e.g., from about 100° C. to 125° C., such as from 105° C. to 125° C.

In one or more embodiments, the stretched extrudate undergoes an optional thermal treatment before diluent removal. In the thermal treatment, the stretched extrudate is exposed to a temperature that is higher (warmer) than the temperature to which the extrudate is exposed during stretching. The planar dimensions of the stretched extrudate (length in MD and width in TD) can be held constant while the stretched extrudate is exposed to the higher temperature. Since the extrudate contains polymer and diluent, its length and width are referred to as the “wet” length and “wet” width. In one or more embodiments, the stretched extrudate is exposed to a temperature in the range of 120° C. to 125° C. for a time sufficient to thermally treat the extrudate, e.g., a time in the range of 1 second to 100 seconds while the wet length and wet width are held constant, e.g., by using tenter clips to hold the stretched extrudate along its perimeter. In other words, during the thermal treatment, there is no magnification or demagnification (i.e., no dimensional change) of the stretched extrudate in MD or TD.

In this step and in other steps such as dry orientation and heat setting where the sample (e.g., the extrudate, dried extrudate, membrane, etc.) is exposed to an elevated temperature, this exposure can be accomplished by heating air and then conveying the heated air into proximity with the sample. The temperature of the heated air, which is generally controlled at a set point equal to the desired temperature, is then conducted toward the sample through a plenum for example. Other methods for exposing the sample to an elevated temperature, including conventional methods such as exposing the sample to a heated surface, infra-red heating in an oven, etc. can be used with or instead heated air.

### Diluent Removal

In one or more embodiments, at least a portion of the diluent is removed (or displaced) from the stretched extrudate to form a dried membrane. A displacing (or “washing”) solvent can be used to remove (wash away, or displace) the diluent, as described in PCT Publication No. WO 2008/016174, for example.

In one or more embodiments, at least a portion of any remaining volatile species (e.g., washing solvent) is removed from the dried membrane after diluent removal. Any method capable of removing the washing solvent can be used, including conventional methods such as heat-drying, wind-drying (moving air), etc. Process conditions for removing volatile species such as washing solvent can be the same as those disclosed in PCT Publication No. WO 2008/016174, for example.

### Stretching the Membrane (Dry Orientation)

Optionally, the membrane is stretched in at least one planar direction after diluent removal. For example, the membrane can be stretched (called “dry stretching” since at least a portion of the diluent has been removed or displaced) in at least MD. A dried membrane that has been dry stretched is called an “oriented” membrane. Before dry stretching, the dried membrane has an initial size in MD (a first dry length) and an initial size in TD (a first dry width). As used herein, the term “first dry width” refers to the size of the dried membrane in the transverse direction prior to the start of dry orientation. The term “first dry length” refers to the size of the dried membrane in the machine direction prior to the start of dry orientation. Tenter stretching equipment of the kind described in WO 2008/016174 can be used, for example.

The dried membrane can be stretched in MD from the first dry length to a second dry length that is larger than the first dry length by a magnification factor (the “MD dry stretching magnification factor”) in the range of from about 1.1 to about 1.5. When TD dry stretching is used, the dried membrane can be stretched in TD from the first dry width to a second dry width that is larger than the first dry width by a magnification factor (the “TD dry stretching magnification factor”). Optionally, the TD dry stretching magnification factor is ≦the MD dry stretching magnification factor. The TD dry stretching magnification factor can be in the range of from about 1.1 to about 1.3. The dry stretching (also called re-stretching since the diluent-containing extrudate has already been stretched) can be sequential or simultaneous in MD and TD. Since TD heat shrinkage generally has a greater effect on battery properties than does MD heat shrinkage, the amount of TD magnification generally does not exceed the amount of MD magnification. When TD dry stretching is used, the dry stretching can be simultaneous in MD and TD or sequential. When the dry stretching is sequential, generally MD stretching is conducted first followed by TD stretching.

The dry stretching can be conducted while exposing the dried membrane to a temperature≦Tm, e.g., in the range of from about Tcd−30° C. to Tm. Tm is the melting peak of the polymer having the lowest melting peak among the polymers used to produce the microporous membrane. In one or more embodiments, the stretching temperature is conducted with the membrane exposed to a temperature in the range of from about 70 to about 135° C., for example from about 80° C. to about 132° C. In one or more embodiments, the MD stretching is conducted before TD stretching, and
(i) the MD stretching is conducted while the membrane is exposed to a first temperature in the range of Tcd−30° C. to about Tm−10° C., for example 70 to about 125° C., or about 80° C. to about 120° C. and
(ii) the TD stretching is conducted while the membrane is exposed to a second temperature that is higher than the first temperature but lower than Tm, for example about 70° C. to about 135° C., or about 127° C. to about 132° C., or about 129° C. to about 131° C.

In one or more embodiments, the MD stretching magnification is in the range of from about 1.1 to about 1.5, such as 1.2 to 1.4; the TD dry stretching magnification is in the range of from about 1.1 to about 1.3, such as 1.15 to 1.25; the MD dry stretching is conducted before the TD dry stretching, the MD dry stretching is conducted while the membrane is exposed to a temperature in the range of 80° C. to about 120° C., and the TD dry stretching is conducted while the membrane is exposed to a temperature in the range of 129° C. to about 131° C.

The stretching rate is preferably 3%/second or more in the stretching direction (MD or TD), and the rate can be independently selected for MD and TD stretching. The stretching rate is preferably 5%/second or more, more preferably 10%/second or more, e.g., in the range of 5%/second to 25%/second. Though not particularly critical, the upper limit of the stretching rate is preferably 50%/second to prevent rupture of the membrane.

### Controlled Reduction of the Membrane's Width After Dry Stretching

Optionally, the membrane is subjected to a controlled reduction in width from the second dry width to a third width, the third dry width being in the range of from the first dry width to about 1.1 times larger than the first dry width. The width reduction is optionally conducted while the membrane is exposed to a temperature≧Tcd−30° C., but no greater than Tm. For example, during width reduction the membrane can be exposed to a temperature in the range of from about 70° C. to about 135° C., such as from about 127° C. to about 132° C., e.g., from about 129° C. to about 131° C. In one or more embodiments, the decreasing of the membrane's width is conducted while the membrane is exposed to a temperature that is lower than Tm. In one or more embodiments, the third dry width is in the range of from 1.0 times larger than the first dry width to about 1.1 times larger than the first dry width.

It is believed that exposing the membrane to a temperature during the controlled width reduction that is ≧ the temperature to which the membrane was exposed during the TD stretching leads to greater resistance to heat shrinkage in the finished membrane.

### Optional Heat Set

Optionally, the membrane is thermally treated (heat-set) at least once following diluent removal, e.g., after dry stretching, the controlled width reduction, or both. It is believed that heat-setting stabilizes crystals and makes uniform lamellas in the membrane. In one or more embodiments, the heat setting is conducted while exposing the membrane to a temperature in the range Tcd to Tm, e.g., a temperature e.g., in the range of from about 100° C. to about 135° C., such as from about 127° C. to about 132° C., or from about 129° C. to about 131° C. Generally, the heat setting is conducted for a time sufficient to form uniform lamellas in the membrane, e.g., a time in the range of 1 to 100 seconds. In one or more embodiments, the heat setting is operated under conventional heat-set “thermal fixation” conditions. The term “thermal fixation” refers to heat-setting carried out while maintaining the length and width of the membrane substantially constant, e.g., by holding the membrane's perimeter with tenter clips during the heat setting.

Optionally, an annealing treatment can be conducted after the heat-set step. The annealing is a heat treatment with no load applied to the membrane, and can be conducted by using, e.g., a heating chamber with a belt conveyer or an air-floating-type heating chamber. The annealing may also be conducted continuously after the heat-setting with the tenter slackened. During annealing the membrane can be exposed to a temperature in the range of Tm or lower, e.g., in the range from about 60° C. to about Tm−5° C. Annealing is believed to provide the microporous membrane with improved permeability and strength.

Optional heated roller, hot solvent, cross linking, hydrophilizing, and coating treatments can be conducted if desired, e.g., as described in PCT Publication No. WO 2008/016174.

While the invention has been described in terms of a monolayer membrane, it is not limited thereto. The invention is compatible with multilayer membranes such as those disclosed in WO2008/016174, which is incorporated by reference herein in its entirety. Such multilayer membranes can have layers comprising polyolefin, such as polyethylene and/or polypropylene. The polyolefin can be the same as those described herein for the monolayer membrane. Although the microporous membrane is described in terms of a “wet” process (e.g., the microporous membrane is produced from a mixture of polymer and diluent), the invention is not limited thereto, and the following description is not meant to foreclose other microporous membranes within the broader scope of the invention, such as membranes made in a “dry” process using little or no diluent.

### Structure and Properties of the Thermoplastic Film

The thermoplastic film comprises at least one non-woven polymeric web and at least one microporous membrane. Optionally, the web and the membrane are in planar (e.g., face-to-face) contact.

In one or more embodiments, the thermoplastic film comprises the non-woven web produced on or laminated with the microporous membrane. The thickness of the thermoplastic film is generally in the range of from about 1.0 μm to about 1.0×10² μm, e.g., from about 5.0 μm to about 30.0 μm. The thickness of the thermoplastic film can be measured by a contact thickness meter at 1 cm longitudinal intervals over the width of 20 cm, and then averaged to yield the membrane thickness. Thickness meters such as the Litematic available from Mitsutoyo Corporation are suitable. Non-contact thickness measurements are also suitable, e.g., optical thickness measurement methods.

In an embodiment, the invention relates to a thermoplastic film, comprising:
(i) a microporous membrane comprising
   (a) polypropylene in an amount in the range of 2.5 wt. % to 40.0 wt. %,
   (b) a first polyethylene in an amount in the range of 60.0 wt. % to 80.0 wt. %, and
   (c) a second polyethylene in an amount in the range of 5.0 wt. % to 30.0 wt. %, the weight percents being based on the weight of the membrane; wherein the polypropylene has an Mw in the range of from 1.05×10⁶ to 2.0×10⁶, an MWD in the range of from 2.0 to 6.0, and a ΔHm≧1.0×10² J/g; first polyethylene has an Mw in the range of 1.0×10⁵ to 9.0×10⁵ and an MWD in the range of from 3.0 to 20.0; and the second polyethylene has an Mw in the range of 1.2×10⁶ to 3.0×10⁶ and an MWD in the range of 4.5 to 10.0; and
(ii) a non-woven web comprising a plurality of fibers having diameters in the range of 0.5 μm to 5.0 μm, the fibers comprising ethylene-octene and/or ethylene-hexene copolymer having a Tm in the range of from 95.0° C. to 130.0° C., a Te-Tm in the range of from 1.0° C. to 5.0° C., an Mw in the range of from 1.5×10⁴ to 5.0×10⁴, and an MWD in the range of 1.8 to 3.5; the non-woven web being bonded to the microporous membrane by lamination of the web to a planar surface of the membrane or by deposition of the fibers on a planar surface of the membrane.

Optionally, the thermoplastic film has one or more of the following properties.

Normalized Air Permeability≦1.0×10³ sec/100 cm³/20 μm

In one or more embodiments, the thermoplastic film's normalized air permeability (Gurley value, measured according to JIS P8117 and normalized to that of an equivalent thermoplastic film having a thickness of 20 μm) is ≦1.0×10³ seconds/100 cm³/20 μm, e.g., in the range of about 20 seconds/100 cm³/20 μm to about 400 seconds/100 cm³/20 μm. Since the air permeability value is normalized to that of an equivalent film having a thickness of 20 μm, the thermoplastic film's normalized air permeability value is expressed in units of “seconds/100 cm³/20 μm”.

Normalized air permeability is measured according to JIS P8117, and the results are normalized to the permeability value of an equivalent film having a thickness of 20 μm using the equation A=20 μm*(X)/T₁, where X is the measured air permeability of a film having an actual thickness T₁ and A is the normalized air permeability of an equivalent film having a thickness of 20 μm.

In an embodiment the thermoplastic film's normalized air permeability is ≦ (i.e. the same or more permeable than) the microporous membrane substrate's normalized air permeability. Optionally, the thermoplastic film's normalized air permeability is in the range of 0.15 to 0.90 times the microporous membrane substrate's air permeability.

### Porosity

In one or more embodiments, the thermoplastic film has a porosity≧25%, e.g., in the range of about 25% to about 80%, or 30% to 60%. The thermoplastic film's porosity is measured conventionally by comparing the film's actual weight to the weight of an equivalent non-porous film of the same composition (equivalent in the sense of having the same length, width, and thickness). Porosity is then determined using the formula: Porosity %=100×(w2−w1)/w2, wherein “w1” is the actual weight of the thermoplastic film and “w2” is the weight of the equivalent non-porous film having the same size and thickness.

### Normalized Pin Puncture Strength

In one or more embodiments, the thermoplastic film has a normalized pin puncture strength≧1.0×10³ mN/20 μm, e.g., in the range of 1.1×10³ mN/20 μm to 1.0×10⁵ mN/20 μm. Pin puncture strength is defined as the maximum load measured at a temperature of 23° C. when a thermoplastic film having a thickness of T₁ is pricked with a needle of 1 mm in diameter with a spherical end surface (radius R of curvature: 0.5 mm) at a speed of 2 mm/second. The pin puncture strength (“S”) is normalized to the pin puncture strength of an equivalent film having a thickness of 20 μm using the equation S₂=20 μm*(S₁)/T₁, where S₁ is the measured pin puncture strength, S₂ is the normalized pin puncture strength, and T₁ is the average thickness of the thermoplastic film.

### Tensile Strength

In one or more embodiments, the thermoplastic film has an MD tensile strength≧95,000 kPa, e.g., in the range of 95,000 to 110,000 kPa, and a TD tensile strength≧90,000 kPa, e.g., in the range of 90,000 kPa to 110,000 kPa. Tensile strength is measured in MD and TD according to ASTM D-882A.

### Tensile Elongation

Tensile elongation is measured according to ASTM D-882A. In one or more embodiments, the thermoplastic film's MD and TD tensile elongation are each ≧100%, e.g., in the range of 125% to 350%. In another embodiment, the thermoplastic film's MD tensile elongation is in the range of, e.g., 125% to 250% and TD tensile elongation is in the range of, e.g., 140% to 300%.

### Shutdown Temperature

The thermoplastic film's shutdown temperature is measured by the method disclosed in PCT Publication No. WO2007/052663, which is incorporated by reference herein in its entirety. According to this method, the thermoplastic film is exposed to an increasing temperature (5° C./minute beginning at 30° C.) while measuring the film's air permeability. The thermoplastic film's shutdown temperature is defined as the temperature at which the film's air permeability (Gurley Value) first exceeds 1.0×10⁵ seconds/100 cm³. The film's air permeability is measured according to JIS P8117 using an air permeability meter (EGO-1T available from Asahi Seiko Co., Ltd.).

In an embodiment, the thermoplastic film has a shutdown temperature≦138.0° C., e.g., in the range of 120.0° C. to 130.0° C., e.g., in the range of from 124.0° C. to 129.0° C.

### MD and TD Heat Shrinkage at 105° C.

In one or more embodiments, the thermoplastic film has MD and TD heat shrinkages at 105° C.≦10.0%, for example from 1.0% to 5.0%. The thermoplastic film's shrinkage in orthogonal planar directions (e.g., MD or TD) at 105° C. is measured as follows:
(i) Measure the size of a test piece of thermoplastic film at ambient temperature in both MD and TD, (ii) expose the test piece to a temperature of 105° C. for 8 hours with no applied load, and then (iii) measure the size of the thermoplastic film in both MD and TD. The heat (or “thermal”) shrinkage in either the MD or TD can be obtained by dividing the result of measurement (i) by the result of measurement (ii) and expressing the resulting quotient as a percent.

In one or more embodiments, the membrane has a TD heat shrinkage at 105° C.≦10%, for example from 0.5% to 5.0%.

### Meltdown Temperature

The thermoplastic film's meltdown temperature is measured by exposing the thermoplastic film to an increasing temperature (5° C./minute beginning at 30° C.) while measuring the thermoplastic film's air permeability (Gurley value). The thermoplastic film's air permeability will decrease and plateau at a Gurley value≧100,000 seconds/100 cm³ at temperatures above the thermoplastic film's shutdown temperature. As the temperature increases further, the thermoplastic film's air permeability will abruptly increase until a baseline value of approximately 0 seconds/100 cm³ is achieved. The thermoplastic film's meltdown temperature is defined as the temperature at which the film's air permeability (Gurley Value) first passes a Gurley value of 100,000 seconds/100 cm³ as the Gurley value decreases to the baseline value. The thermoplastic film's air permeability is measured according to JIS P8117 using an air permeability meter (EGO-1T available from Asahi Seiko Co., Ltd.). In an embodiment, the film has a meltdown temperature≧145.0° C., e.g., in the range of 150° C. to 200° C., such as 175° C. to 195° C.

The thermoplastic film has well-balanced shutdown temperature and air permeability, and is permeable to liquid (aqueous and non-aqueous) at atmospheric pressure. Thus, the microporous membrane can be used as a battery separator, filtration membrane, etc. The thermoplastic film is particularly useful as a BSF for a secondary battery, such as a nickel-hydrogen battery, nickel-cadmium battery, nickel-zinc battery, silver-zinc battery, lithium-ion battery, lithium-ion polymer battery, etc. In an embodiment, the invention relates to lithium-ion secondary batteries containing BSF comprising the thermoplastic film.

Such batteries are described in PCT publication WO 2008/016174 which is incorporated by reference herein in its entirety.

This invention will be described in more detail with reference to Examples below without intention of restricting the scope of this invention.

### EXAMPLES

Four thermoplastic films are produced on a Reifenhauser 500 mm bicomponent meltblown line. A non-woven web of meltblown fibers are blown onto commercially-available microporous membranes summarized in Table 1 below.

TABLE 1
Base films

| | | Normalized Air | | Shutdown Temperature and | | |
|---|---|---|---|---|---|---|
| Microporous | | Permeability | Normalized Pin | Meltdown Temperature | | Basis |
| Membrane | Thickness | Sec/100 | Puncture Strength | SDT | MDT | weight |
| Substrate | μm | cm³/20 μm | gF | ° C. | ° C. | g/m² |
| 1 | 16 | 280 | 350 | 133 | 145 | 10 |
| 2 | 20 | 280 | 410 | 135 | 185 | 12 |
| 3 | 25 | 620 | 590 | 131 | 155 | 15 |

Two linear low density polyethylene resins are used to produce the meltblown fibers. Resin A is a linear low density polyethylene having a melt index at 190° C. of 155 and a Tm of 125° C. (DOW DNDA 1082 NT®). Resin B is a linear low density polyethylene having a melt index at 190° C. of 595 and a Tm of 115° C.

Meltblowing process conditions for producing the thermoplastic films of samples 1-4 are shown in Table 2.

The meltblown web is produced by (1) continuously feeding the resin to an extruder, (2) simultaneously melting the resin and forcing the resin through a spinneret to extrude the resin into fibers; (3) solidifying the fibers by transferring the heat to the surrounding air. In the meltblown process, the spinneret has a single 500 mm row of capillaries, each having a diameter in the range of 0.1 to 0.5 mm. There are 30 capillary exit holes per linear inch (25.4 mm) of die width. The fibers are then deposited on the microporous membrane substrate to produce the web.

Properties of the thermoplastic film are listed in Table 3.

TABLE 2

| | | Microporous | | Primary | Primary | | | |
|---|---|---|---|---|---|---|---|---|
| | | Membrane | Melt Temp | Air Temp | Air Flow | Throughput | Web-forming | MB Basis Weight |
| Film I.D. No. | Resin | Substrate | at Die Tip (° C.) | (° C.) | (liters/sec) | (ghm) | Distance (mm) | (g/m²) |
| 1 | A | 3 | 212 | 231 | 78.4 | 0.1 | 50 | 5.3 |
| 2 | B | 1 | 195 | 205 | 85.0 | 0.06 | 100 | 5 |
| 3 | B | 2 | 187 | 184 | 78.4 | 0.06 | 100 | 2 |
| 4 | B | 1 | 194 | 205 | 78.4 | 0.1 | 100 | 3 |

TABLE 3

| | | | | | Shutdown | | | |
|---|---|---|---|---|---|---|---|---|
| | | | | | and | | | |
| | | | Normalized | Normalized Pin | Meltdown | | Web | Thermoplastic |
| | | Average | Air | Puncture | Temperature | | Basis | Film |
| Example | Film | Thickness | Permeability | Strength | SDT | MDT | weight⁽¹⁾ | Basis weight |
| No. | I.D. No. | μm | Sec./100 cm³/20 μm | gF | ° C. | ° C. | g/m² | g/m² |
| 1 | 1 | 41.9 | 252 | 296 | 128.3 | 147.8 | 3.8 | 19.0 |
| 2 | 1 | 41.7 | 258 | 300.2 | 128.2 | 147.0 | 4.0 | 19.2 |
| 3 | 2 | 58.7 | 92.7 | 128 | 131.1 | 145.5 | 6.4 | 16.4 |
| 4 | 3 | 39.7 | 117 | 209 | 134.1 | 172.8 | 1.0 | 13.0 |
| 5 | 4 | 54.1 | 96.5 | 129 | 131.8 | 145.6 | 4.2 | 14.2 |

Referring to Table 3, the thermoplastic film of Example 2 is the same as the thermoplastic film of Example 1, but measured a second time to show that the results are reproducible.

Examples 1-5 demonstrate the successful production of thermoplastic film comprising a microporous membrane substrate and a non-woven polymeric web deposited thereon. The examples show that in all cases the thermoplastic film has a lower shutdown temperature than the microporous membrane substrate without significantly degraded air permeability or meltdown temperature.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow. Each of the appended claims defines a separate invention, which for infringement purposes is recognized as including equivalents to the various elements or limitations specified in the claims. Depending on the context, all references herein to the “invention” and/or “embodiment” generally refer to certain specific embodiments only. It should be understood embodiments relating to certain aspects of the invention have been described in greater detail. The invention is not limited to these embodiments, versions, and examples.

1. A thermoplastic film comprising:
a microporous polymeric membrane; and
a non-woven web bonded to the polymeric microporous membrane, wherein the web comprises a plurality of fibers comprising polyolefin having a Tm≧85.0° C. and a Te-Tm≦10.0° C.

2. The thermoplastic film of claim 1, wherein the polyolefin comprises polyethylene having an Mw of 1.5×10⁴ to 5.0×10⁴ and an MWD of 1.5 to 5.0.

3. The thermoplastic film of claim 1, wherein the polyolefin comprises polyethylene homopolymer.

4. The thermoplastic film of claim 1, wherein the polyolefin comprises polyethylene copolymer.

5. The thermoplastic film of claim 2, wherein the polyethylene has a melt index of ≦1.0×10².

6. The thermoplastic film of claim 1, wherein the polyolefin has a Tm of 95.0° C. to 130.0° C., and a Te-Tm of 1.0° C. to 5.0° C.

7. The thermoplastic film of claim 4, wherein the polyethylene copolymer comprises ≦10.0 mol. % of hexene-1 or octene-1 comonomer, and wherein the polyethylene copolymer has a CDBI≧50.0%, an Mw of 1.5×10⁴ to 5.0×10⁴, an MWD of 1.8 to 3.5, a Tm of 100.0° C. to 126.0° C., and a Te-Tm of 2.0° C. to 4.0° C.

8. The thermoplastic film of claim 1, wherein the microporous polymeric membrane comprises polyethylene and/or polypropylene.

9. The thermoplastic film of claim 1, wherein the microporous polymeric membrane comprises polyethylene having an Mw≦1.0×10⁶.

10. The thermoplastic film of claim 1, wherein the polymeric microporous membrane is multi-layered and at least one layer comprises polypropylene.

11. The thermoplastic film of claim 10, wherein the polypropylene has an Mw≧1.0×10⁶ and a heat of fusion≦1.0×10² J/g.

12. The thermoplastic film of claim 1, wherein the thermoplastic film has a shutdown temperature≦138° C.

13. The thermoplastic film of claim 1, the thermoplastic film having a meltdown temperature≧145.0° C.

14. The thermoplastic film of claim 1, the thermoplastic film having a normalized air permeability≦1.0×10³ sec/100 cm³/20 μm, a porosity≧25%, and a normalized pin puncture strength≧3.0×10³ mN/20 μm.

15. A battery separator film comprising the thermoplastic film of claim 1.

16. A method for producing a thermoplastic film comprising combining a non-woven web and a microporous polymeric membrane, the web comprising a plurality of fibers comprising polyolefin having a Tm≧85.0° C. and a Te-Tm≦10.0° C.

17. The method of claim 16, wherein the polyolefin comprises a copolymer of ethylene and ≦10.0 mol. % of an octane-1 or hexane-1 comonomer, and wherein the copolymer has a CDBI≧50.0% by weight, an Mw of 1.5×10⁴ to 5.0×10⁴, an MWD of 1.8 to 3.5, a Tm of 100.0° C. to 126.0° C., and a Te-Tm of 2.0° C. to 4.0° C.

18. The method of claim 16, wherein the microporous polymeric membrane comprises polypropylene having an Mw≧1.0×10⁶ and a heat of fusion≧1.0×10².

19. The method of claim 16, wherein the web is produced by meltblowing the polyolefin at a primary hot air flow rate of 9.5 liters/sec to 11.3 liters/sec per 2.54 cm of die width, a primary hot air pressure of 115 kPa to 205 kPa, a primary hot air temperature of 200° C. to 350° C., and at a polyolefin throughput rate of 0.01 ghm to 1.25 ghm.

20. The thermoplastic film product of claim 16.

21. A battery comprising an anode, a cathode, an electrolyte, and a separator situated between the anode and the cathode, the separator comprising:
a microporous polymeric membrane; and
a non-woven web bonded to the polymeric microporous membrane, wherein the web comprises a plurality of fibers comprising polyolefin having a Tm≧85.0° C. and a Te-Tm≦10° C.

22. The battery of claim 21, wherein the polyolefin comprises polyethylene having an Mw of 1.5×10⁴ to 5.0×10⁴ and an MWD of 1.5 to 5.0.

23. The battery of claim 21, wherein the polyolefin comprises comonomer, and the copolymer has a CDBI≧50.0%, an Mw of 1.5×10⁴ to 5.0×10⁴, an MWD of 1.8 to 3.5, a Tm of 100.0° C. to 126.0° C., and a Te-Tm of 2.0° C. to 4.0° C.

24. The battery of claim 21, wherein the separator has a normalized air permeability≦1.0×10³ sec/100 cm³/20 μm, a porosity≧25%, and a normalized pin puncture strength≧3.0×10³ mN/20 μm.

25. The battery of claim 21, wherein the battery is a lithium ion secondary battery.
